(19) United States
(12) Patent Application Publication
(10) Pub. No.: US 2022/0324475 A1
(43) Pub. Date: Oct. 13, 2022

(54) DRIVING SUPPORT DEVICE, MOVING APPARATUS, DRIVING SUPPORT METHOD, AND STORAGE MEDIUM

(71) Applicant: CANON KABUSHIKI KAISHA, Tokyo (JP)

(72) Inventor: Kazuya Nobayashi, Tokyo (JP)

(21) Appl. No.: 17/714,870

(22) Filed: Apr. 6, 2022

(30) Foreign Application Priority Data
Apr. 9, 2021 (JP) 2021-066307

(51) Int. Cl. B60W 50/16; B60W 40/08; G06V 20/58

(52) U.S. Cl. CPC B60W 50/16; B60W 40/08; G06V 20/58; B60W 2050/146

(57) ABSTRACT

A device has a vicinity monitoring unit that generates vicinity conditions information representing conditions of the vicinity of a moving apparatus; a driver monitoring unit that generates line of sight information representing a line of sight region of a line of sight direction of a driver of the moving apparatus; a detection unit that detects the number and positions of subjects that are present in a first region set in a predetermined direction of the moving apparatus by using the vicinity conditions information; and a control unit that executes a first notification in relation to the subject when the subject is included in the line of sight region, and to execute a suppressed second notification in relation to the subject when the subject is not included in the line of sight region.

### BACKGROUND

### Technical Field

The aspect of the embodiments relates to a driving support device for a driver of a moving apparatus, a moving apparatus, a driving support method, a storage medium, and the like.

### Description of Related Art

In moving apparatuses such as automobiles and the like, a method of using an in-vehicle camera to monitor the vicinity conditions of the vehicle, and in the case in which there is an object (referred to below as a subject) that will hinder the travel of the vehicle, notifying the driver of the presence of the subject has been proposed. For example, Japanese Unexamined Patent Application, First Publication No. 2019-120994 discloses a method for quickly making a driver notice a subject by displaying, on a display device, an emphasized image that emphasizes a subject that is in front of the vehicle.

However, when the subject is just displayed as emphasized, the driver focuses on the region that has been emphasized and displayed. Due to this, the driver's attention toward other fields of view is lowered, presenting the issue that this method is not actually preferable from the point of view of traffic safety.

### SUMMARY

A device has at least one processor; and a memory coupled to the at least one processor, the memory having instructions, that when executed by the processor, to function as: a vicinity monitoring unit configured to generate vicinity conditions information representing the conditions of the vicinity of a moving apparatus, a driver monitoring unit configured to generate line of sight region information representing a line of sight region of a line of sight direction of a driver of the moving apparatus, a detection unit configured to detect the number and position of subjects that are present in a first region that has been set in a predetermined direction of the moving apparatus by using the vicinity conditions information, and a control unit configured to execute a first notification relating to a subject in a case in which the subject is included in the line of sight region, and to execute a second notification relating to a subject in a case in which the subject is not included in the line of sight region, wherein the subject detection unit further sets a second region on the outer side of the first region, and wherein the notification control unit suppresses the second notification that is performed for the subject in the second region.

Further features of the present disclosure will become apparent from the following description of embodiments with reference to the attached drawings.

### BRIEF DESCRIPTION OF THE DRAWINGS

FIG. 1 is a block diagram showing the configuration of a driving support device according to the First Embodiment.

FIG. 2A is a diagram showing an example of a configuration of a driver monitoring unit 110, and FIG. 2B is a flow chart explaining the flow of the processing that is performed by an attention region detection device 840.

FIG. 3 is a diagram explaining a first region in the First Embodiment.

FIG. 4 is a flow chart of the First Embodiment.

FIG. 5A is a diagram showing an example of the relationship between a vehicle and a subject in the First Embodiment, FIG. 5B is a diagram explaining the information representing the position of the subject, FIG. 5C is a diagram explaining the notification method of providing notification about the position of the subject using a notification control unit, FIG. 5D is a diagram explaining the relationship between the attention region of a driver and the position of a subject, and FIG. 5E is a diagram explaining a method for suppressing notifications about the position of a subject using the notification control unit.

FIG. 6 is a diagram explaining a second region in the Second Embodiment.

FIG. 7 is a flow chart of the driving support device in the Second Embodiment.

FIG. 8A is a diagram showing another example of the relationship between a vehicle and a subject in the Second Embodiment, FIG. 8B is a diagram explaining an example of a method of providing notification about the position of the subject by using the notification control unit in the case of FIG. 8A, and FIG. 8C is a diagram of the conditions in FIG. 8A as seen from above.

FIG. 9 is a diagram explaining a vicinity monitoring device that is installed on a road according to the Second Embodiment.

FIG. 10A is a system configuration diagram schematically showing the configuration of the driving support device of the Third Embodiment, and FIG. 10B is a flow chart of the driving support device of the Third Embodiment.

FIG. 11A is a diagram explaining an example of the first region at moderate to low speed according to the Third Embodiment, and FIG. 11B is a diagram explaining an example of the first region at high speed. FIG. 11C is a diagram explaining an example of the first region in the case in which there is a crosswalk on the road in the travel direction, and FIG. 11D is a diagram explaining an example of the first region in the case in which there is a guard rail on the side of the road in the travel direction.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate descriptions will be omitted or simplified.

In addition, the embodiments explain examples of a driving support device that has been mounted on a vehicle such as an automobile or the like as the driving support device. However, the driving support device also includes driving support devices that have been mounted on moving apparatuses such as airplanes, ships, trains, and the like. Furthermore, driving support devices that remotely operate moving apparatuses such as drones, robots, and the like are also included.

### The First Embodiment

Below, a detailed explanation of the First Embodiment of the present disclosure will be given while referencing the attached drawings.

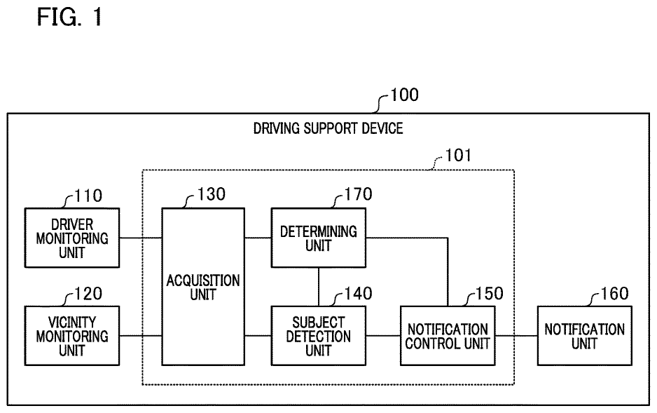

FIG. 1 is a block diagram showing the configuration of a driving support device according to the First Embodiment. A driving support device 100 has been mounted on, for example, a vehicle such as an automobile or the like serving as a moving apparatus, and includes a driver monitoring unit 110, a vicinity monitoring unit 120, a control unit 101, a notification unit 160, and the like.

The control unit 101 includes an acquisition unit 130, a subject detection unit 140, a notification control unit 150, a determining unit 170, and the like.

The driving support device has a built-in CPU serving as a computer, which functions as a control unit configured to control the operations of each unit inside the driving support device 100 based on a computer program that has been recorded (stored) to be computer-readable on a memory (storage medium).

The driver monitoring unit 110 uses captured images that have been acquired by an image capturing apparatus that captures images of the interior of the vehicle, detects the line of sight direction of the driver of the vehicle, and generates line of sight region information representing a line of sight region that is a predetermined angle range of the line of sight direction (driver monitoring process). Note that the line of sight region of the line of sight direction of the driver can be deemed to be the attention region that the driver is paying attention to in the state in which the driver is driving, and in the embodiments, the line of sight region information is also called the attention region information.

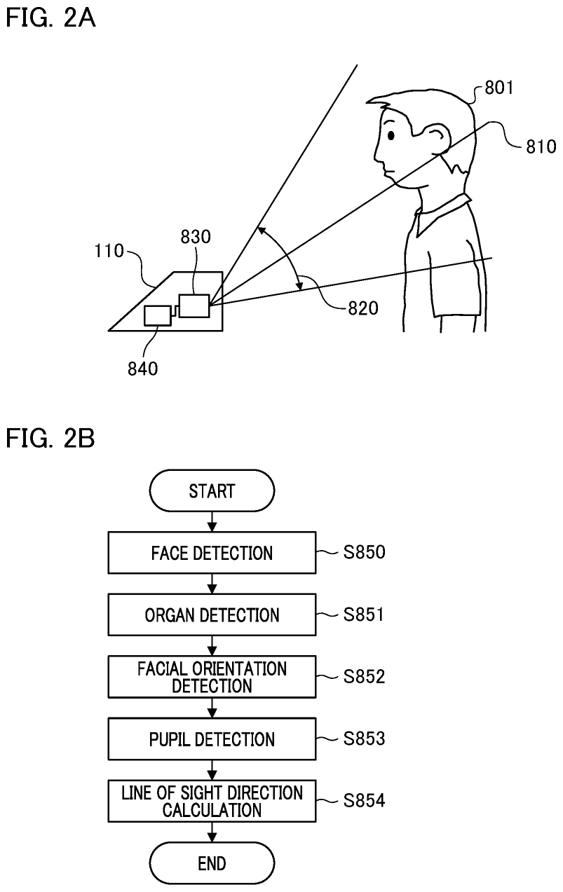

A method of detecting the attention region of a driver 801 using the driver monitoring unit 110 will be explained below using FIG. 2A and FIG. 2B. FIG. 2A is a diagram showing an example of a configuration of the driver monitoring unit 110.

An image capturing apparatus 830 that the driver monitoring unit 110 is provided with is provided with an image forming optical system, and an image capturing element that captures images that have been formed by the image forming optical system, and generates a driver image by capturing images of the interior of the vehicle including a driver 801. In FIG. 2A, 820 represents the angle of view the image capturing apparatus 830, and 810 represents the optical axis of the image forming optical system. The driver monitoring unit 110 uses the driver image that is acquired by the image capturing apparatus 830 and performs processing for detecting the attention region (line of sight region) of the driver with an attention region detection apparatus 840. The attention region detection apparatus 840 also has a built-in CPU serving as a computer, which controls the operations of the attention region detection apparatus 840 based on a computer program that has been recorded (stored) on a memory. Note that the driver monitoring unit 110 may also be a unit that acquires captured images from an image capturing apparatus that has been provided separately from the driving support device 100, and then generates driver images.

FIG. 2B is a flow chart explaining the flow of the processing that is performed by the attention region detection apparatus 840. The processing for each step in FIG. 2B is performed by the CPU that has been built into the attention region detection apparatus 840 executing the computer program that has been recorded (stored) on the memory.

In step S850, the attention region detection apparatus 840 performs detection of a facial region based on the driver image. In step S851, the attention region detection apparatus 840 detects each organ such as the eyes, nose, and mouth, and the like based on the facial region that was detected in step S850. Well-known methods can be used for the facial region and organ detection. For example, the detection can be performed by recognizing feature amounts such as HoG (Histograms of Oriented Gradients), or the like with a support vector machine (SVM).

In step S852, the attention region detection apparatus 840 uses the positions of each of the organs that were detected in step S851, and detects the direction in which the driver's face is oriented. That is, the attention region detection apparatus 840 compares the positions of each organ on the driver's face with the positions of each organ on a standard model of a face, and calculates the direction of the standard model of the face that is the best match for the positions of each of the organs. The direction of the standard model of the face that has been calculated is made the direction in which the driver's face is oriented.

In step S853, the attention region detection apparatus 840 extracts an image of the eye region that was detected in step S851, and calculates the position of the center of the pupil. The pupil is the region that has the lowest luminance value in captured images of the eye, and therefore, by searching for the region with the lowest luminance value among the regions of the eye, the position of the center of the pupil can be detected.

In step S854, the attention region detection apparatus 840 uses the optical axis 810 of the image capturing apparatus 830, the orientation of the driver's face that was detected in step S852, and the position of the center of the pupil that was detected in step S853, and detects the line of sight of the driver.

The line of sight direction of the driver relative to the optical axis 810 can be calculated by using the orientation of the driver's face and the center of the pupil. The line of sight direction of the driver can be calculated by associating it with a predetermined direction of the vehicle by using the angle between the optical axis 810 and a predetermined direction of the vehicle (for example, the travel direction of the vehicle). The region on which the driver is focusing (attention region, line of sight region) can be calculated by setting the line of sight direction of the driver at the starting point of the head position of the driver in the vehicle, which has already been set.

The head position of the driver uses a position that has already been set. However, in order to calculate the attention region more precisely, in one embodiment, the head position is calculated in accordance with the movements of the driver. For example, in the image capturing apparatus that is disclosed in Patent Reference Publication 2, the captured image and the distance to the subject are acquired at the same time by acquiring an image from the beams of light that have passed through the different pupil regions of the image forming optical system with which the image capturing apparatus is provided. The head position of the driver can be calculated more precisely by acquiring the distance from the image capturing apparatus 830 to the head of the driver at the same time as the captured image.

The vicinity monitoring unit 120 in FIG. 1 uses captured images that are acquired by an image capturing unit that captures images of the exterior of the vehicle, and generates vicinity conditions information representing the conditions of the vicinity of the vehicle serving as the moving apparatus (vicinity monitoring process). A stereo camera that has been provided with two image forming optical systems and two image capturing elements disposed on each anticipated focal plane can be used as the image capturing apparatus with which the vicinity monitoring unit 120 of the present example is provided. The captured images that are output from each image capturing element of the stereo camera are images that have parallaxes corresponding to distance.

The distance to the subject information in the captured image is calculated by using a well-known method to detect the parallax amount based on the captured image that is output from the stereo camera, and converting the detected parallax amount using a predetermined coefficient. Furthermore, the subject and the category of the subject or the like are detected using well-known machine-learning on the captured image that is output from the image capturing elements of either of the stereo cameras. The distance information for subjects in the vicinity of the vehicle can be calculated for each pixel position of the captured images that are output from each of the image capturing elements of the stereo cameras. Therefore, the number and position of subjects can be calculated by using the detection results for the subject and the distance information for the vicinity of the vehicle.

The acquisition unit 130 acquires the line of sight region information (attention region information) from the driver monitoring unit 110, and acquires the vicinity conditions information from the vicinity monitoring unit 120 (acquisition process). The subject detection unit 140 uses the vicinity conditions information acquired by the acquisition unit 130, and detects the number and position of subjects that are present in a first region that has already been set (subject detection process). It is assumed that the first region is set as the region, from among the regions in the vicinity of the vehicle, that is positioned in the travel direction of the vehicle.

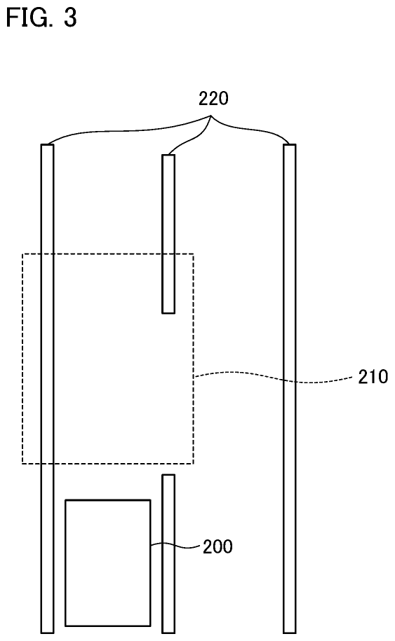

FIG. 3 is a diagram explaining the first region in the First Embodiment, and shows a vehicle 200 that is driving on a road as seen from above. In FIG. 3, the vehicle 200, which has been provided with the driving support device 100 of the present Embodiment, is travelling in the direction from the bottom to the top of the diagram. The first region 210 has been set as in front of the vehicle 200 (travel direction). Note that in the Third Embodiment, as will be described below, the position and shape of the first region 210 may be altered according to the speed or the like of the vehicle 200.

The determining unit 170 determines whether or not the driver of the vehicle has noticed the presence and position of each subject (whether or not the subject is in the line of sight), based on the line of sight information acquired by the acquisition unit 130 and the number and positions of the subjects that are present in the first region that have been detected by the subject detection unit 140.

The notification control unit 150 generates notification information based on at least one of the determination results of the determining unit 170 or the detection results of the subject detection unit 140, and the image information that has been captured by the vicinity monitoring unit 120, which is included in the vicinity conditions information. Then, the notification unit 160 performs a notification to the driver based on the notification information.

The notification unit 160 has a display device such as a liquid crystal display or the like for displaying the notification information.

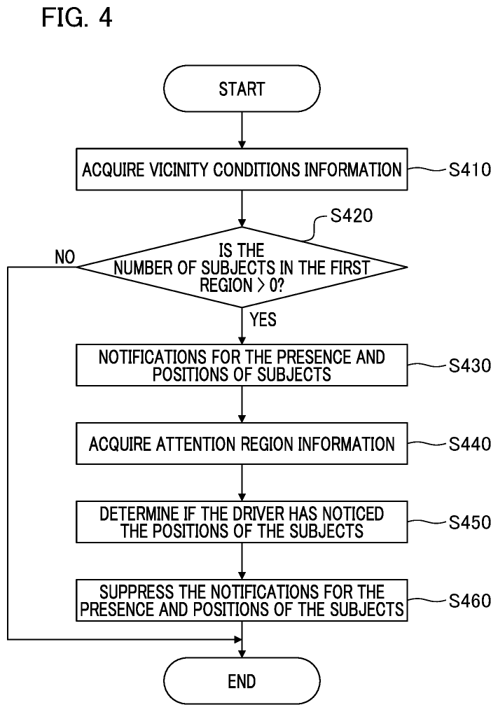

FIG. 4 is a flow chart of the First Embodiment, and the operations of the driving support device 100 of the present Embodiment will be explained using FIG. 4. The processing of each step in FIG. 4 is performed by the internal computer of the driving support device executing the computer program that has been recorded (stored) on the memory.

In Step S410, the acquisition unit 130 acquires the vicinity conditions information from the vicinity monitoring unit 120.

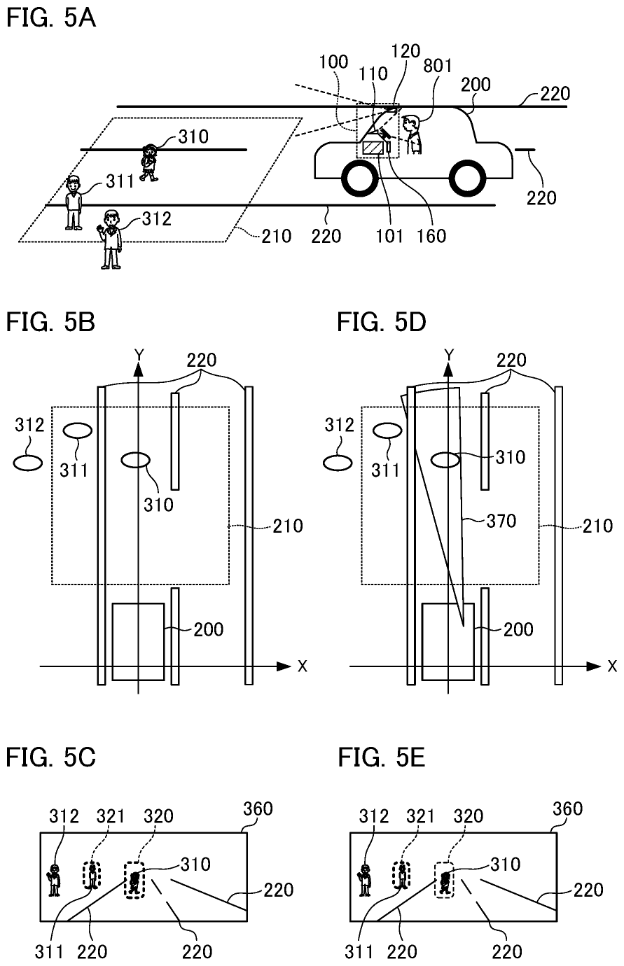

FIG. 5A is a diagram showing an example of the relationship between the vehicle and the subject in the First Embodiment. The vicinity conditions information will be explained assuming that the vehicle 200 is in the conditions of FIG. 5A. In FIG. 5A, a person 310 and a person 311, who are subjects, are present in the first region 210. Additionally, a person 312, who is a subject, is present outside of the first region 210.

The vicinity monitoring unit 120 that the vehicle 200 is provided with detects the people 310 to 312, and generates the number of subjects and the positions of the people 310 to 312 as the vicinity conditions information.

FIG. 5B is a diagram explaining the information representing the positions of the subjects. The predetermined position of the vehicle 200 is the origin, the travel direction of the vehicle is the Y axis, and the direction perpendicular to the Y axis is the X axis. The coordinate information on which the people 310 to 312 are positioned on the XY plane can be made information that expresses the positions of the subjects.

In step S420, whether or not the number of subjects present in the first region, which has been detected (calculated) by the subject detection unit 140 using the vicinity conditions information, is greater than zero is determined. In the conditions in FIG. 5 A, and FIG. 5B, the coordinate information on the XY plane for each of the people 310 to 312 is compared to the region information of the first region 210, and it is calculated that the number of subjects in the first region 210 is two. In step S420, in the case in which the number of subjects is greater than zero (S420 Yes), the processing proceeds to step S430, and in the case in which the number of subjects is zero (S420 No) because there are no subjects for which notification is required, the processing is completed.

In Step S430, using the information about the number and position of the subjects that are present in the first region and were detected by the subject detection unit 140, the notification control unit 150 generates notification information, and notifies the driver about the positions of the subjects by using the notification unit 160 (notification control process).

FIG. 5C is a diagram explaining the notification method for the positions of the subjects using the notification control unit.

The display region 360 is the image display region of the liquid crystal display or the like of the notification unit 160. The notification information that is displayed in the notification region 360 is information that superimposes a box 320 and a box 321 on the image information that has been captured by the vicinity monitoring unit 120.

The positions of the box 320 and the box 321 are calculated by using the position information on the XY plane for the person 310 and the person 311, assuming that the surface of the road on which the vehicle 200 is driving and the optical axis of the image capturing apparatus that the vicinity monitoring unit 120 is provided with are parallel. The size of the box 320 and the box 321 are set based on the Y coordinate values of the person 310 and the person 311. Note that the person 312 is outside of the first region, and therefore, has not been superimposed with a box. By displaying the subjects with the box 320 and the box 321 superimposed on the notification unit 160, it is possible for the driver to quickly notice that there are subjects that they should be cautious of that are in the path of the vehicle or in the vicinity of its path.

Note that the notification unit 160 is not limited to a display device such as a liquid crystal screen or the like with which the vehicle 200 has been provided, and may also be a head-up display that synthesizes virtual images onto real images by projecting images onto the front windshield of the vehicle 200. In this case, the notification control unit 150 will generate a virtual image such that the box 320 and the box 321 are each displayed as being superimposed on the positions that correspond to the person 310 and the person 311 who are visible to the driver through the front windshield.

In Step S440, the acquisition unit 130 acquires the attention region information (line of sight information) from the driver monitoring unit 110.

In step S450, the determining unit 170 uses the information about the number and positions of the subjects that are present in the first region and were detected by the subject detection unit 140, as well as the attention region information (line of sight region information), and determines where or not the driver has noticed the positions of the subjects. That is, the determining unit 170 determines whether or not the subjects are in the line of sight region.

In this way, in the present embodiment, in the case in which a subject is in the line of sight region, in normal driving conditions, it is assumed that the subject is in the attention region, along with being assumed that the driver has noticed the position of the subject. However, the processing may also be made to, for example, detect the frequency of each time that the line of sight of the driver is oriented toward the subject, and in the case in which the frequency is greater than a predetermined number of times, distinguish whether the subject is in the line of site region or if the driver has noticed the position of the subject. By using such a configuration, it is possible to increase the precision of the judgements as to whether or not a subject is in the attention region and whether or not the driver has noticed a subject's position.

FIG. 5D is a diagram explaining the relationship between the attention region (line of sight region) of the driver and the position of the subject, and in the same manner as FIG. 5B, the predetermined position of the vehicle 200 is the origin, the travel direction of the vehicle is the Y axis, and the direction perpendicular to the Y axis is the X axis.

370 is the attention region (line of sight region) of the driver, and the direction in which the driver is focusing is expressed as the region 370, with the head position of the driver as the starting point. The attention region of the driver and the position of the subjects (person 310, and the person 311) are compared, and the subjects that are inside the attention region (line of sight region) are determined. In the example in FIG. 5D, the person 310 is inside the attention region of the driver (line of sight region), and therefore, it is determined that the driver has noticed the person 310.

In step S460, the notification control unit 150 generates notification information that suppresses the notifications about the positions of the subjects for the subjects that the driver of the vehicle has noticed the positions of (subjects in the attention region (line of sight region)), and notifies the driver by using the notification unit 160 (notification control process).

FIG. 5E is a diagram explaining a method for making suppressing the notifications about the positions of the subjects less conspicuous using the notification control unit. The box 320 corresponding to the person 310, who is a subject whose position the driver has already noticed, is displayed less conspicuously than the notification in FIG. 5C. That is, in FIG. 5E, a less conspicuous notification (first notification) is made for the box 320 by using a fine broken line. In contrast, the box 321 corresponding to the person 311, who is a subject whose position driver has not noticed, continues to have an emphasized notification (second notification).

That is, in FIGS. 5C and 5E, the box 321 is expressed with a thick broken line for emphasizing the notification, while the box 320 corresponding to the subjects whose position the driver has already noticed (subjects in the attention region of focus), the notification about the subjects' position is suppressed to be less conspicuous by making the thickness of the box thin. For example, changing the color of the box to a color that does not stand out, lowering the color saturation of the box, lowering the brightness of the box, in the case in which the box is made to blink, making the blinking period longer, or, having no notification be made by deleting the box may also be used as the method for making the notification less conspicuous. That is, the way in which the notification is made less conspicuous also includes making no notification. Furthermore, the internal color of the box or the internal brightness of the box may be changed so as not to stand out, a combination of these may be used, and any method may be used to make the box not stand out. In other words, the control of making the box not stand out can also be lowering the visibility towards the driver.

In this way, the notification control unit of the present embodiment is made to perform notifications by displaying a predetermined image by using the image display apparatus. In addition, the vicinity conditions information includes captured images that are captured of the vicinity of the moving apparatus, and the notification control unit generates box information on the captured images in order to emphasize and display the subjects that have been detected by the subject detection unit.

In addition, along with performing notifications by performing emphasized display of the subjects that are outside of the line of sight region, the notification control unit suppresses the emphasized display of the subjects in the attention region.

In this way, notifications about the subjects whose positions the driver has already noticed (subjects in the attention region) are suppressed according to the driving support device of the present embodiment. As a result thereof, the driver's attention towards fields of sight in which there are subjects whose positions the driver has not noticed can be more drawn.

Note that in step S460, notifications about the positions of the subjects that the driver of the vehicle has already noticed the positions of (subjects that are in the attention region) are made less conspicuous. However, in this case, notification information that is even more emphasized than usual may be generated to notify the driver of the positions of the subjects whose positions the driver has not noticed (subjects that are outside of the attention region).

For example, in FIG. 5E, the box 321 may be made a thicker broken line, or may be made to stand out even more. That is, when a notification about a subject that is in the line of sight region is suppressed, the notifications about the subjects that are outside of the line of sight region may be made to be emphasized even more.

In addition, although the notification control unit of the present embodiment performs notifications by using a display apparatus that displays an image, the notifications to the driver may also be performed by using sound or vibration. In that case, a speaker or a vibrator can be used as the notification unit, and the degree of stress of the notification can be performed using the degree of stress of the sound or vibration. In addition, notifications to the driver may also be performed by using multiple methods from among an image display, a sound, or a vibration.

In addition, in one embodiment, the moving apparatus on which the driving support device of the present embodiment is mounted be provided with a movement control unit that performs control of the movement operations (movement speed, movement direction, and the like) of the moving apparatus in connection with the operations of the notification control unit of the present embodiment. For example, in the case in which, despite a notification having been made by the notification control unit, the distance between the moving apparatus and the subject has become less than a predetermined distance, the movement control unit will reduce the moving speed of the moving apparatus or cause it to stop by causing the moving apparatus to brake, thereby avoiding a collision.

In the above case, the movement control unit may be made to avoid a collision with the subject by changing the movement direction of the moving apparatus. In addition, the operations of the movement control unit inside the moving device may be performed by the computer that has been internally provided in the moving apparatus executing the computer program that has been stored (recorded) on the memory.

### Second Embodiment

In the Second Embodiment, the subject detection unit 140 sets a second region outside of the first region 210. Then, the operations performed by the determining unit 170 and the notification unit 150 are made to differ in the case in which the subject is positioned within the first region, and in the case in which the subject is positioned in the second region.

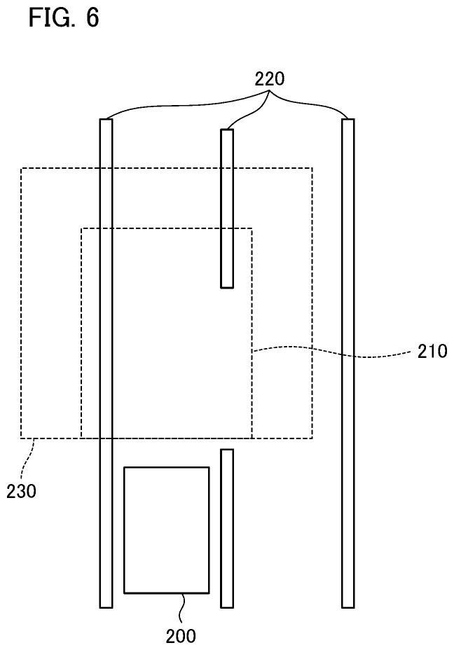

FIG. 6 is a diagram explaining the second region in the Second Embodiment. The second region 230 is set on the outer side of the travel direction side of the vehicle 200 in the first region 110, such as, for example, the square C shaped second region in FIG. 6. In the case in which there is a subject inside of the first region 210, this will be the region that has a high possibility of collision with the vehicle 200 in comparison to the second region. Note that each of the sizes of the regions in FIG. 3 and FIG. 6 are examples, and the size of each region is not limited to the sizes that are shown in the drawings.

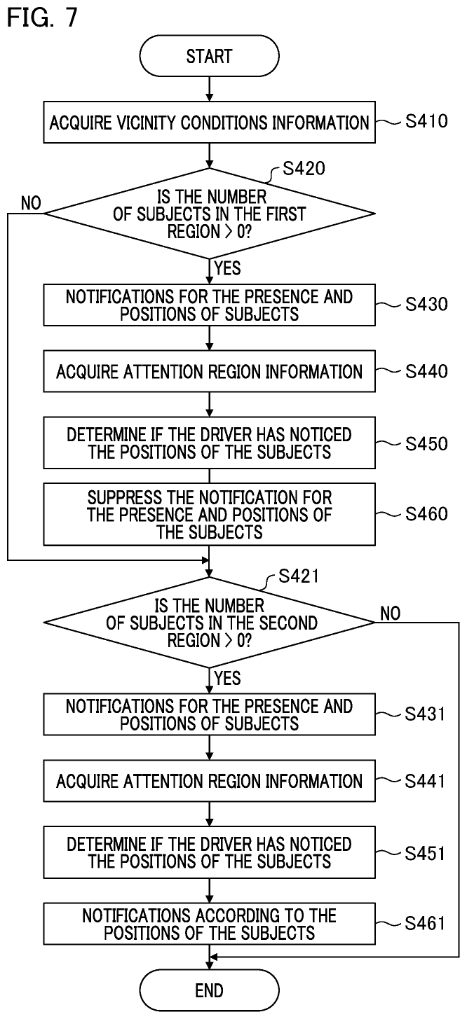

FIG. 7 is a flow chart of the driving support device in the Second Embodiment, and explains the operations of the driving support device 100 in a case in which the second region that is used by the subject detection unit 140 has been set on the outer side of the first region. Each step of the processing in FIG. 7 is executed by the internal computer of the driving support device executing the computer program that has been stored (recorded) on the memory.

In FIG. 7, the contents of the processing from step S410 to step S460 are the same as those in FIG. 4, and in step S410, the acquisition unit 130 acquires the vicinity conditions information from the vicinity monitoring unit 120.

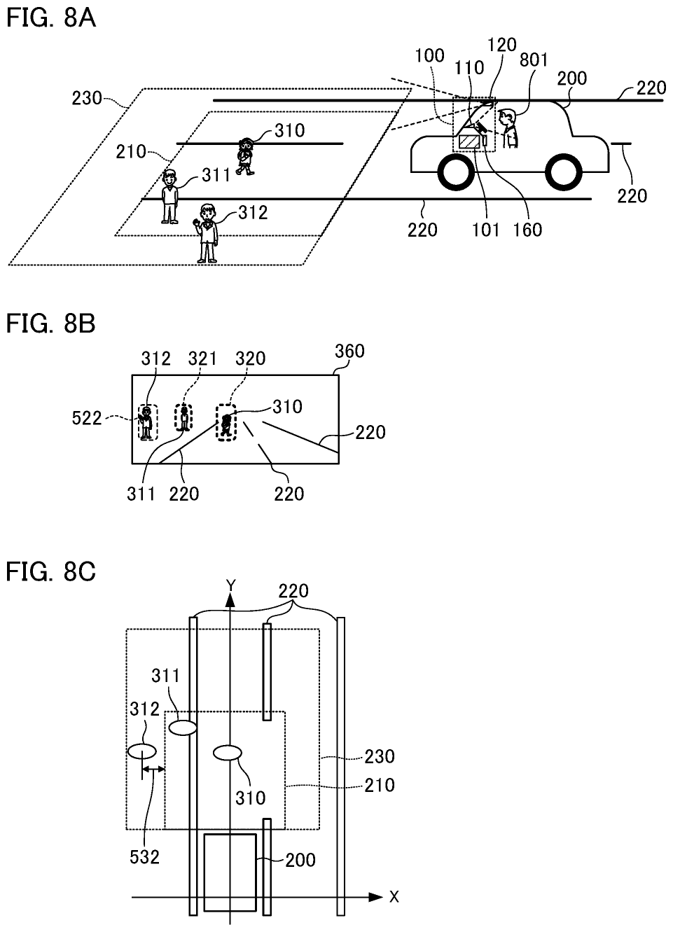

FIG. 8A is a diagram showing another example of the relationship between the vehicle and the subject in the Second Embodiment.

In FIG. 8A, the person 310 and the person 311, who are subjects that are in the first region 210, are present. In addition, the person 312, who is a subject that is in the second region 230 on the outer side of the first region 210, is present.

The vicinity monitoring unit 120 with which the vehicle 200 is provided detects the people 310 to 312, and generates the number of subjects and the positions of the people 310 to 312 as the vicinity conditions information.

In the flow in FIG. 7, the vicinity conditions information is explained assuming that the vehicle 200 is in the conditions of FIG. 8A.

The contents of the processing from step S411 to step S460 are the same as the processing of FIG. 4, and therefore an explanation thereof will be omitted, and the contents of the processing from step S421 and after will be explained.

In step S421, the subject detection unit 140 calculates the number of subjects that are included in the second region by using the vicinity conditions information. In the conditions of FIG. 8A, the number of subjects inside the second region 230 is calculated as being one by comparing the coordinate information on the XY plain for each of the people 310 to 312 with the region information for the second region 230. In step S421, in the case in which the number of subjects is greater than zero, the processing proceeds to step S431, and in the case in which the number of subjects is zero, there are no subjects for which notification is necessary, and thus, the processing is completed.

In step S431, the notification control unit 150 uses the information about the number and position of the subjects that are included in the second region 230 and were detected by the subject detection unit 140, generates notification information, and uses the notification unit 160 to notify the driver about the positions of the subjects. FIG. 8B is a diagram explaining an example of a method of notifying the driver of the position of the subject by using the notification control unit in the case of FIG. 8A. In FIG. 8B, the box 522 is displayed by being superimposed on the subject (person 312) that is in the second region 230.

In step S431, the notification for the subject inside the second region is more suppressed or less conspicuous than the notifications for the subjects in the first region by showing the box 522 using a broken line that is thinner than those of the boxes 320 and 321. That is, the notification control unit controls the second notification that is performed with respect to the subject in the second region more than the second notification with respect to the subjects in the first region. This is due to the person 312 being positioned inside of the second region 230, and therefore being a subject with a lower risk of collision in comparison to the person 310 and the person 311.

However, the second region 230 is a region that is adjacent to the first region 210, and therefore, it is possible that the subjects that are positioned in the second region 230 will move into the first region 210. Therefore, although notifications are also performed for subjects that are positioned in the second region 230, the notifications are displayed after being controlled. By differentiating the subjects that the driver should be immediately cautious of, and the subjects that may later become objects that the driver should be cautious of, it is possible to quickly make the driver notice these subjects.

In step S441, the acquisition unit 130 acquires the attention region information (line of sight region information) from the driver monitoring unit 110.

In step S451, the determining unit 170 determines where or not the driver has noticed the positions of the subjects in the second region based on the information about the number and positions of the subjects that are included in the second region and were detected by the subject detection unit 140, as well as the line of sight region information (attention region information). That is, the determining unit 170 determines whether or not a subject is in the attention region.

In step S461, the notification control unit 150 generates notification information according to the positions of the subjects for the subjects that were determined to be positioned in the second region 230, and determined to be subjects that the driver has not noticed the positions of in step S451, and notifies the driver by using the notification unit 160. In this context, an explanation of the notification information according to the positions of the subjects will be given by using FIG. 8C.

FIG. 8C is a diagram of the conditions in FIG. 8A as seen from above.

The notification control unit 150 emphasizes notifications by displaying the box 522 with a broken line that becomes thicker the closer the distance 532 from the person 312 in the second region 230 to the first region 210 becomes, or the greater the approaching speed of the person 312 towards the first region 210 becomes. The notification information is thereby generated according to the position of the subject. That is, the notification control unit puts a greater emphasis on notifications the closer the position of a subject in the second region becomes to the first region, or the greater its approaching speed toward the first region becomes.

Subjects that are positioned in the second region 230 may possibly later become subjects that the driver should be cautious of, and the closer that their distance to the first region 210 becomes, or, the greater that their approaching speed becomes, the higher this possibility becomes. Therefore, by emphasizing notifications according to the distance 532 or the approaching speed, the driver can be made notice how cautious they should be of the subjects that they should be cautious of later.

A stereo camera that is able to acquire captured images and distance information at the same time is used as the vicinity monitoring unit 120 of the present embodiment. However, it is sufficient if the driving support device of the present embodiment is able to acquire the vicinity conditions information for the automobile. Articles that monitor the vicinity conditions of a vehicle, such as, for example, millimeter wave radar, or LiDAR or the like may also be used as the vicinity monitoring unit 120.

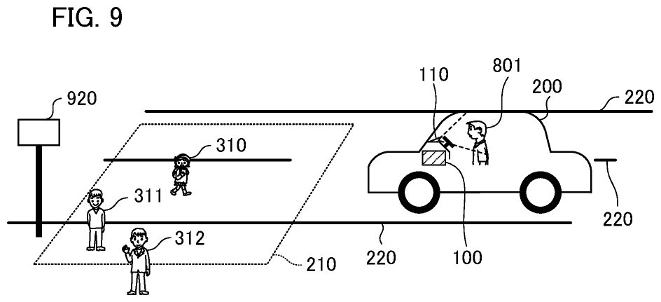

FIG. 9 is a diagram explaining a vicinity monitoring device that is installed on the road according to the Second Embodiment. A vicinity monitoring device 920 may be disposed, for example, ahead of a sharp curve on the road such as the one that is shown in FIG. 9, and the driving support device may be made to acquire vicinity conditions information for the vehicle 200 from the vicinity monitoring apparatus 920 via wireless communication. Conversely, the driving support device may be made to acquire vicinity conditions information from both of the vicinity monitoring unit 120 with which the vehicle 200 is provided, and the vicinity monitoring device 920 that is installed on the road. By acquiring vicinity conditions information from the vicinity monitoring apparatus 920 that is installed on the road, the detection of subjects can also be performed for regions that are blind spots of the vehicle 200, and there is a greater improvement in the safety of the vehicle while it is in operation.

### Third Embodiment

A detailed description of the Third Embodiment of the present disclosure will be given below with reference to the attached drawings.

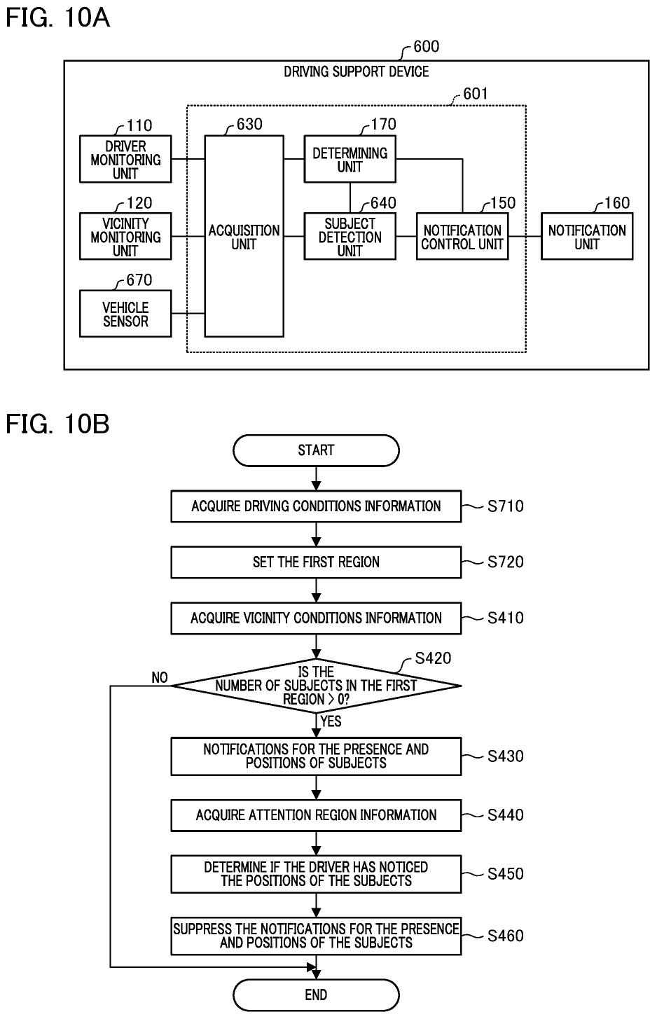

FIG. 10A is a system configuration diagram schematically showing the configuration of the driving support device of the Third Embodiment. A driving support device 600 is further provided with a vehicle sensor 670.

The vehicle sensor 670 includes a vehicle speed sensor, a direction indicator, a steering sensor, a navigation system, and the like, and functions as a sensor that detects the movement conditions of the moving apparatus. An acquisition unit 630 is able to acquire driving conditions information (the vehicle speed, the planned route, the type of roads in the vicinity (the presence or absence of sidewalks, and the like)) from the vehicle sensor 670. 601 is a control unit.

A subject detection unit 640 of the present embodiment sets a first region by using the driving conditions information that has been acquired by the acquisition unit 630, and calculates the number of subjects that are included in the first region using the vicinity conditions information, The driving support device 600 has a built-in CPU serving as a computer, and functions as a control unit configured to control the entirety of the operations and the like of the driving support device 600 based on a computer program that has been recorded (stored) on a memory.

FIG. 10B is a flow chart of the driving support device of the Third Embodiment, and the operations of the driving support device 600 in the Third Embodiment will be explained using the flow chart in FIG. 10B. Each step in FIG. 10B is processed by the internal computer of the driving support device 600 executing the computer program that has been stored (recorded) on the memory.

In step S710, the acquisition unit 130 acquires the driving conditions information from the vehicle sensor 670.

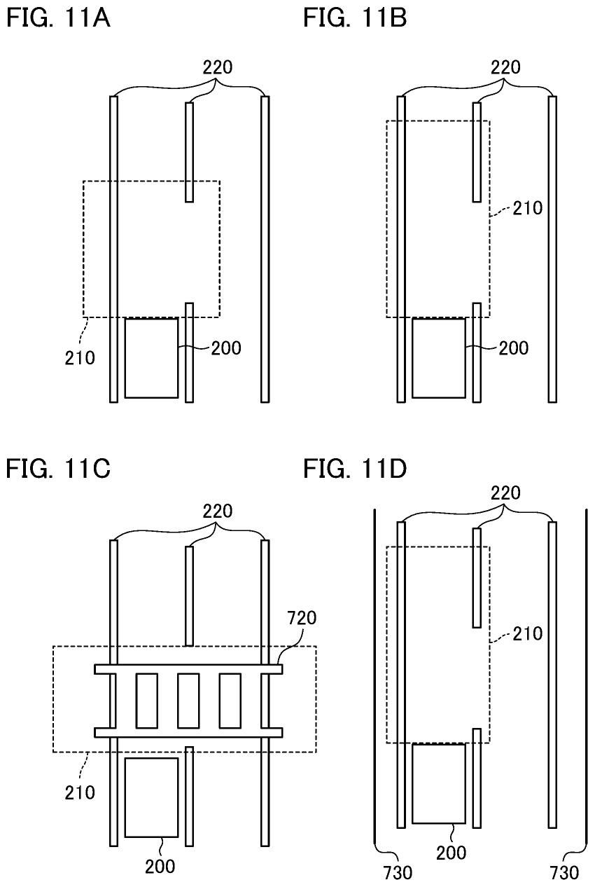

In step S720, the subject detection unit 640 uses the driving conditions information to set a first region. The setting method for the first region will be explained using FIG. 11.

FIG. 11A is a diagram explaining an example of the first region at moderate to low speed according to the Third Embodiment, and FIG. 11B is a diagram explaining an example of the first region at high speed. FIGS. 11A and 11B show a first region that has been set in front of the vehicle 200 in the same manner as FIG. 2. In the case in which the vehicle speed information for the vehicle 200 that is included in the driving conditions information shows that the vehicle 200 is at medium speed (for example 20 to 50 km/hour), the first region 210 is set as shown in FIG. 11A.

In the case in which the vehicle speed information for the vehicle 200 that is included in the driving conditions information shows that the speed of the vehicle 200 is a high speed (for example 50 to 100 km/hour), the first region 210 shown in FIG. 11B is set. That is, the subject detection unit 640 sets the first region according to the speed of the vehicle 200. The faster the speed of the vehicle 200 becomes, the longer in the travel direction of the vehicle 200 the first region 210 will be set to be, and the first region 210 will be set to become narrow in the direction that is perpendicular to the travel direction. That is, the subject detection unit sets the first region as longer in the travel direction of the moving apparatus the faster the moving speed of the moving apparatus becomes, and the first region is set to be shorter in the direction that is perpendicular to the travel direction of the moving apparatus.

In addition, FIG. 11C is a diagram explaining an example of a first region in the case in which there is a crosswalk on the road in the travel direction, and FIG. 11D is a diagram explaining an example of the first region in the case in which there is a guard rail on the side of the road in the travel direction. As shown in FIGS. 11C, and 11D, the shape of the first region 210 may be altered according to the type of roads or the like in the vicinity that are included in the driving conditions information.

That is, the subject detection unit may be made to set the first region based on information related to the road in the travel direction of the moving apparatus, which is included in the vicinity conditions information. For example, as is shown in FIG. 11C, in the case in which a crosswalk 720 is included on the road in the vicinity, it is possible that pedestrians will cross the road, and therefore, an oblong first region 210 has been set to include the crosswalk. That is, the subject detection unit sets the first region to include the crosswalk based on the information related to the crosswalk, which is in the travel direction of the moving apparatus that is included in the vicinity conditions information.

As is shown in FIG. 11D, in the case in which there is a guard rail 730 on the side of the automobile road, the possibility that a subject will appear from that side is low, and therefore, the first region 210 is set to be long and narrow in the travel direction. That is, in the case in which there is a guard rail on the side of the road in the travel direction of the moving apparatus, the first region is made so as to be set as long in the travel direction of the moving apparatus, and as short in the direction that is perpendicular to the travel direction. In addition, the travel direction of the vehicle may be predicted, and the first region on the travel direction side may be widened, or its position may be shifted based on the information from the direction indicator of the vehicle that is included in the driving conditions information.

In the driving support device of the present embodiment, the first region is set according to the driving conditions of the vehicle. That is, the driving support device has a sensor that detects the movement conditions of the moving apparatus, acquires movement conditions information from the sensor, and the subject detection unit sets the shape and the like of the first region according to the movement conditions information. In this way, by setting the region in which subjects that the driver will be notified about are detected according to the driving conditions, the driver can be notified about subjects even more quickly, and therefore, there is a greater improvement in the safety of the vehicle while it is in operation.

While the present disclosure has been described with reference to exemplary embodiments, it is to be understood that the disclosure is not limited to the disclosed exemplary embodiments. The scope of the following claims is to be accorded the broadest interpretation to encompass all such modifications and equivalent structures and functions. In addition, as a part or the whole of the control according to this embodiment, a computer program realizing the function of the embodiment described above may be supplied to the driving support device through a network or various storage media. Then, a computer (or a CPU, an MPU, or the like) of the driving support device may be configured to read and execute the program. In such a case, the program and the storage medium storing the program configure the present disclosure.

This application claims the benefit of Japanese Patent Application No. 2021-066307 filed on Apr. 9, 2021, which is hereby incorporated by reference herein in its entirety.

What is claimed is:

1. A device comprising:
least one processor; and
a memory coupled to the at least one processor, the memory having instructions, that when executed by the processor, to function as:
a vicinity monitoring unit configured to generate vicinity conditions information representing conditions of the vicinity of a moving apparatus;
a driver monitoring unit configured to generate line of sight information representing a line of sight region of a line of sight direction of a driver of the moving apparatus;
a detection unit configured to detect a number and positions of subjects that are present in a first region that has been set in a predetermined direction of the moving apparatus by using the vicinity conditions information; and
a control unit configured to execute a first notification in relation to the subject in a case in which the subject is included in the line of sight region, and to execute a second notification in relation to the subject in a case in which the subject is not included in the line of sight region,
wherein the detection unit further sets a second region on an outer side of the first region, and
wherein the control unit suppresses the second notification that is performed for the subject in the second region.

2. The device according to claim 1, wherein the first notification is a less conspicuous notification than the second notification.

3. The driving support device according to claim 1, wherein the first notification includes cases in which no notification is made.

4. The device according to claim 1, wherein the control unit performs the notifications by displaying a predetermined image by using a display apparatus.

5. The device according to claim 1,
wherein the vicinity conditions information includes a captured image that has been captured of the vicinity of the moving apparatus, and
wherein the control unit performs at least the second notification by performing an enhanced display on the captured image that enhances the subjects that were detected by the subject detection unit.

6. The device according to claim 5, wherein the control unit performs the enhanced display for the subjects that are outside of the line of sight region in the second notification, and suppresses the enhanced display for the subjects that are in the line of sight region in the first notification.

7. The device according to claim 1, wherein the control unit performs notifications by sound or vibration.

8. The device according to claim 1, wherein the control unit puts a greater emphasis on the second notification for the subject in the second region in a case where the subject in the second region becomes closer to the first region.

9. The device according to claim 1,
wherein the device has a sensor configured to detect the movement conditions of the moving apparatus, and
wherein the detection unit sets the first region according to movement conditions information that has been acquired from the sensor.

10. The device according to claim 9, wherein the movement conditions information includes information relating to the moving speed of the moving apparatus, and the detection unit sets the first region to be longer in the travel direction of the moving apparatus the faster the moving speed becomes.

11. The device according to claim 10, wherein the detection unit sets the first region as being narrower in the direction perpendicular to the travel direction of a moving vehicle the faster the moving speed becomes.

12. The device according to claim 9,
wherein the vicinity conditions information includes information relating to the road in the travel direction of the moving apparatus, and
wherein the subject detection unit sets the first region based on the information relating to the road.

13. The device according to claim 9,
wherein the vicinity conditions information includes information relating to crosswalks in the travel direction of the moving apparatus, and
wherein the detection unit sets the first region so as to include the crosswalks.

14. The device according to claim 9, wherein in the case in which there is a guard rail on a side of the road in the travel direction of the moving apparatus, the detection unit sets the first region to be longer in the travel direction of the moving apparatus, and narrower in the direction perpendicular to the travel direction than in a case in which there is not a guard rail on the side of the road.

15. An apparatus comprising:
at least one processor; and
a memory coupled to the at least one processor, the memory having instructions, that when executed by the processor, to function as:
a vicinity monitoring unit configured to generate vicinity conditions information representing conditions of the vicinity of a moving apparatus;
a driver monitoring unit configured to generate line of sight information representing a line of sight region of a line sight direction of a driver of the moving apparatus;
a detection unit configured to detect the number and positions of subjects that are present in a first region that has been set in the travel direction of a moving vehicle by using the vicinity conditions information;
a notification control unit configured to execute a first notification in relation to the subject in a case in which the subject is included in the line of sight region, and to execute a second notification in relation to the subject in a case in which the subject is not included in the line of sight region; and
a movement control unit configured to perform control of the movement operations of the movement apparatus in connection with the operations of the notification control unit.

16. A method comprising
generating vicinity conditions information representing conditions of the vicinity of a moving apparatus;
generating line of sight information representing a line of sight region of a line of sight direction of a driver of the moving apparatus;
detecting a number and position of subjects that are present in a first region that has been set in a predetermined direction of a moving vehicle by using the vicinity conditions information; and
controlling a first notification in relation to the subject in a case in which the subject that was detected in the subject detection process is included in the line of sight region, and a second notification in relation to the subject in a case in which the subject is not included in the line of sight region,
wherein the detecting further executes to set a second region on an outer side of the first region, and
wherein the controlling executes to suppress the second notification that is performed for the subject in the second region.

17. The method according to claim 16, wherein the controlling performs notifications by sound or vibration.

18. A non-transitory computer-readable storage medium configured to store a computer program of instructions for causing a computer to perform a method comprising:
generating vicinity conditions information representing conditions of the vicinity of a moving apparatus;
generating line of sight information representing a line of sight region of a line of sight direction of a driver of the moving apparatus;
detecting the number and position of subjects that are present in a first region that has been set in a predetermined direction of the moving vehicle using the vicinity conditions information; and
controlling a first notification in relation to the subject in a case in which the subject that has been detected in the subject detection process is included in the line of sight region, and a second notification in relation to the subject in a case in which the subject is not included in the line of sight region,
wherein the detecting further executes to set a second region on an outer side of the first region, and
wherein the controlling executes to suppress the second notification that is performed for the subject in the second region.

19. The non-transitory computer-readable storage medium according to claim 18, wherein the controlling performs notifications by sound or vibration.
